(19) United States
(12) Patent Application Publication
(10) Pub. No.: US 2007/0253522 A1
(43) Pub. Date: Nov. 1, 2007

(54) Single Plaiting Nuclear Fuel and Method for the Production Thereof

(75) Inventors: Alain Ballagny, Les Molieres (FR); Nuria LLorca, Barcelona (ES)

Correspondence Address: OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 10/551,902

(22) PCT Filed: Apr. 7, 2004
(86) PCT No.: PCT/FR04/50148

§ 371 Date: Feb. 28, 2007

(30) Foreign Application Priority Data
Apr. 9, 2003 (FR) 0304434

(51) Int. Cl. G21C 3/30

(52) U.S. Cl. 376/426

(57) ABSTRACT

The invention relates to a high-density fissile material nuclear fuel in the form of an assembly (1) of elementary wires, most of which are constituted by fissile material, wherein said wires are assembled by stranding, braiding or weaving and said assembly is contained in a stainless ductile casing (2), which elementary wires are compressed by deforming said casing (2), and the elementary wires of fissile material are fine enough to allow for the size accommodation of the fuel under the effects of irradiation during burnup and for the gaseous fission products to be removed. The invention also relates to a method for producing said nuclear fuel.

### TECHNICAL FIELD

This invention relates to a high-density fissile material nuclear fuel and the method for production thereof.

### PRIOR ART

The performance of experimental reactors in achieving high neutron flows is directly dependent on the performance of fuels. However, this is limited by the amount of fissile material capable of being contained in the fuels, and in particular by their fissile material density and their homogeneity which should be as high as possible; it is also limited by their ability to easily exchange the heat produced during fission with the coolant of the primary circuit, without reaching excessively high temperatures capable of damaging the fuels. Finally, the discharge of gaseous fission products must be ensured.

The fissile material density will be quantified below in grams per cm³. When the fissile material is uranium, the unit will be written as gU/cm³, i.e. grams of uranium per cm³.

Experimental reactors use primarily plate-type fuels, but also cruciform fuels.

The plates of plate-type fuels are produced by roll bonding a mixture of fissile materials in powder form (uranium, plutonium, americium or alloys thereof) and a ductile metal, such as, for example, aluminium, zirconium or copper. In practice, they are most often compounds of a uranium alloy (for example: UAl or UMo, which are ductile, U₃Si₂, . . . ) and aluminium powder between two aluminium plates. When the alloy is not ductile, as is the case for U₃Si₂, it becomes necessary to increase the content of ductile metal powder. This method has been the subject of a number of developments in order to increase the uranium density of the fuel (see document [1]), with this parameter being considered to be essential for the performance of reactors. However, with this method, it is not possible to roll mixtures with more than 50% by volume of uranium alloy. For example, for a plate-type fuel produced by roll bonding a mixture of uranium and aluminium powders, it is not possible to significantly increase the amount of fissile material since the method requires the uranium to be mixed with at least 50% by volume of aluminium particles in order to obtain the required ductility. Moreover, the use of aluminium reduces the maximum allowable temperature to around 150° C. in order to prevent any corrosion. The uranium density was therefore increased essentially by searching alloys having a high uranium content. Thus, the reactors successively used alloys UAl, UO₂, U₃Si₂ and now UMo enabling densities of 2 gU/cm³, 2 gU/cm³, 6 gU/cm³ and, for UMo, 8 gU/cm³, respectively. These values correspond to theoretical values under ideal conditions, weighted by a certain coefficient taking production defects into account. For the first three alloys, fairly well known to manufacturers, these weighted values correspond to the values actually obtained. However, this is not the case for a newer alloy such as UMo: the theoretical value under ideal conditions is 14 to 15 gU/cm³, the value weighted by the known coefficient taking production defects into account should be around 8 gU/cm³, but the value obtained in practice is between 2 and 2.5 gU/cm³.

The cruciform fuels (see document [2]) are produced by sintering a mixture of powders of uranium, uranium oxide (UO₂) and other constituents essentially including copper, which provides the necessary ductility. It is entirely in the form of powders mixed so as to be as uniform as possible, and then placed inside a ductile stainless steel tube. Once filled, this tube is then deformed by successive passages into rollers until it has the desired cross shape. It is then cut to the appropriate length to form the sheath.

For cruciform fuels, the cross shape allows for a very good exchange with the coolant, and the use of stainless steel makes these fuels insensitive to a temperature increase. These fuels are therefore potentially very good candidates for enhancing the performance of experimental reactors, on condition that their uranium density can be increased. These fuels typically consist of a mixture of U, UO₂ and copper powders, and their fissile material density is only 2 gU/cm³. By replacing the UO₂ powder with UMo powder and increasing the proportion of UMo, a weighted theoretical density of 8 to 10 gU/cm³ can be achieved. However, in practice, the product of document [2] obtains values of only around 2.2 to 2.5 gU/cm³. However, it appears to be difficult to go above these values when using powder technology.

This invention results from considerations regarding the increase in the density of fuels intended for experimental reactors. It has been deduced from the prior art that the ideal fuel in terms of performance and irradiation resistance should have the following features:
a (theoretical) density of around 14 to 15 gU/cm³,
uranium or uranium alloy grains of around 50 to 150 micrometers and surrounded with an additional material to improve the thermal conductivity and limit the irradiation-induced swelling,
a fuel porosity of several percent, uniformly distributed in order to remove the fission gases. In practice, plate-type fuels hardly appear to be capable of significantly exceeding 6 gU/cm³, and cruciform fuels are limited to around one third of this value.

### DESCRIPTION OF THE INVENTION

The aim of the invention is to provide a high-density fissile material nuclear fuel, also having good performance under irradiation and a good removal of gaseous fission products. The expression “good performance under irradiation” means good dimensional stability and good heat transfer.

This aim is achieved by a high-density fissile material nuclear fuel characterised in that it has, in the form of an assembly of elementary wires, the main portion of which consists of fissile material, wherein said wires are assembled by stranding, braiding or weaving and said assembly is contained in a ductile stainless casing, wherein the elementary wires are compressed by deformation of said casing, and the elementary fissile material wires are fine enough to allow space accommodation for the fuel under the effects of irradiation during burnup and the removal of gaseous fission products.

The deformation of the casing is advantageously performed until the free spaces between the elementary wires occupy only 3 to 15% of the internal section of the casing after deformation.

In other words, the features of high-density of fissile material, good performance under irradiation and good removal of gaseous fission products are achieved by arranging the fissile material into fine elementary wires, which wires are optionally combined with elementary wires made of another metal to enhance the ductility or the performance under irradiation, wherein all of these elementary wires are assembled by braiding or stranding, and surrounded with a stainless ductile metal casing (acting as a sheath) which has been deformed so that the elementary wires are compressed and slightly deformed, and have between them only a small amount of free space. The elements thus produced are nuclear fuel elements, referred to as “rods” when the ductile metal casing is a tube. As the invention aims to increase the fissile material density of the fuel, most of the elementary wires are made of fissile material.

It should be noted that the diameter of the elementary wires and their braiding in the stainless ductile sheath are selected so that the fuel adapts well to the effects of irradiation during burnup, and so that the gaseous fission products can be easily removed.

According to a specific embodiment, the deformation of the casing is performed so that the elementary wire cross-section is deformed and the cross-sections of two adjacent wires fit together.

The fissile material is advantageously selected from the group including uranium, plutonium, americium, their alloys or a combination of several of these elements.

Said alloys are advantageously selected from the group including UMo and UAl.

The fissile material is preferably a UMo alloy comprising around 8% by mass of molybdenum.

It is noted that the ductile and stainless metal of the casing is preferably stainless steel 316 L or 316 LN.

Alloys such as UO₂ or U₃Si₂, currently used in powder form, cannot be used to produce the invention due to their lack of ductility, which prevents the wires from being produced.

The elementary wires preferably have a diameter between 10 μm and 100 μm, with their initial cross-section being circular. However, they are compressed by shrinking the internal volume of the sheath (rolling, roller burnishing) after filling with the “braided” assembly. This compression is performed so as to optimise the fuel density, as well as to promote heat transfer, the space accommodation under irradiation and the removal of gaseous fission products. This compression crushes the wires slightly, giving them a slightly polygonal cross-section, which significantly enhances heat transfer. More specifically, “slightly polygonal” means that the two convex surfaces pressed against one another have local deformations tending to flatten them out and to fit them specifically together. This compression can be quantified by the percentage of space existing in a transversal cross-section, which is around 3 to 15%, and preferably around 10%.

According to a specific embodiment, the elementary wire assembly consists only of wires having the same composition.

According to another embodiment, the elementary wire assembly consists of wires having different compositions.

In other words, the elementary wires can all be made up of a fissile material, but they can also be combined with elementary wires made of another metal to enhance the ductility or the performance under irradiation of the nuclear fuel.

The elementary wire assembly preferably comprises between 60% and 90% by volume of UMo wires, 3 to 15% of gaps, with the remainder consisting of wires made of other materials. In other words, in a transversal cross-section, 60% to 90% of the internal surface of the sheath is occupied by wires made of a UMo alloy, 3 to 15% by gaps and the remainder by wires made of other materials. In the specific case in which this percentage reaches 90%, and the gaps represent 10% of the cross-section, all of the wires used are made of UMo.

According to a first special case, the wires have identical diameters.

According to a second special case, the wires have different diameters.

The elementary wire assembly is advantageously in the form of a braid.

According to an alternative, the elementary wire assembly has a strand form. The strand is advantageously a compound strand free of a central strand.

According to an alternative, the elementary wire assembly is woven.

The advantage of forming these metals into wires is that they provide the benefits of the metal in general (density, heat conductivity, easy to shape, etc.) without having the disadvantages of solid metal in the form of pellets or bars (irradiation-induced swelling). Indeed, it is known that irradiation-induced swelling of uranium alloys is in particular associated with the impossibility for the fission gases to migrate toward the thickness of the pellet or the bar; in a wire design, if the wires are fine enough, the fission products can reach the surface of the wires and migrate in the space between the wires which allows for a more direct and faster removal than in a porous material. In addition, the disadvantages of powders or objects produced from powders are avoided: the need for a certain degree of ductility requiring significant additions of non-fissile material, with a resulting lack of uniformity.

The existence of a large number of elementary wires facilitates the production of regular and functionally uniform assemblies of various components (mixed fuels) or the modification of the properties of the fuel itself by adding additional metal wires to the assembly to improve the ductility or the performance under irradiation. It is thus possible to combine wires of different types in an organised and controlled manner, when they are in a metallurgic state that makes it possible to implement a so-called “braided” assembly, which below will designate an actual braided assembly as well as an assembly obtained by single or compound strands.

When the assembly is obtained by stranding, it is advantageous not to place a central strand along the neutral axis of the assembly so as to preserve the uniformity of the assembly and facilitate its size accommodation to the effects of irradiation during burnup.

Another advantage of the invention lies in the continuous form of the gaps, in microchannels between the elementary wires, which promote the rapid removal of gaseous fission products. According to the prior art, porosity makes for some removal, but the communication of the series of empty micro spaces was much more random and less direct. This removal is further facilitated when there is no central strand.

This invention also covers any assembly of nuclear fuel rods described above.

Another aim of the invention lies in the method for producing the nuclear fuel described above. This method comprises the following steps:
production of elementary wires of a predetermined composition, with the main portion being wires of fissile material,
production of at least one assembly using said wires,
placement of the assembly in a stainless and ductile casing,
shaping of said filled tube.

The steps of the method are preferably as follows:

a) forming the fissile material into fine and regular wires,

b) optionally forming wires made of one or more different materials to enhance the ductility or the characteristics of the final fuel under irradiation,

c) if step b exists, producing the uniform mixture of wires from said step b with the fissile material wires from step a,

d) assembling the wires,

e) inserting one or more assemblies from step d into a stainless and ductile metal casing, the uniformity and regularity of the assembly being preserved,

f) shaping the casing.

The shaping of the stainless ductile casing is preferably performed so as to slightly crush the wires and leave as gap only 3% to 15% of the transversal cross-section delimited by the internal surface of the casing.

If necessary, the filled casing can be cut to the required length for each nuclear plant using the fuel, and as necessary it can be inserted into a second casing required by this nuclear plant.

According to a specific embodiment, the casing is a tube, there is only one assembly in the casing and the shaping is performed by drawing it through a drawplate or by rolling.

According to another embodiment, the casing is a tube, there is only one assembly and the shaping is performed by roller burnishing.

According to another embodiment, the casing is flattened and contains several assemblies placed parallel with respect to one another in a uniform manner, and the shaping of this casing thus filled is performed by pressing or rolling.

Any method for producing wires is suitable for the implementation of the invention, in particular methods for producing uniform wires of 10 to 100 μm using the metals already specified. We used the rotating plate method (see document [3]) optimised for the physical characteristics specific to the alloy used. This method is based on the projection onto a rotating disk of a stream of molten alloy. With this method, the wires have a diameter and a controlled chemical composition. Its use in the production of UMo wires will be described in the discussion of embodiments of the invention.

Compounding, single or compound stranding, as well as braiding are familiar enough to a person skilled in the art that they do not require further description here.

If the stainless ductile casing is a tube, the insertion of the “braided” assembly into the stainless and ductile tube is performed using another wire, a stronger tension wire that has been previously inserted, and the assembly is attached, for example with a hook or by welding. After attachment of the assembly to this draw wire, the latter is drawn so as to move the assembly into the tube.

If the casing is planar, there should be a series of several assemblies, all parallel and arranged regularly with respect to one another, as uniformly as possible. Then, the mechanical deformation is applied by any means, while making sure not to change the arrangement of the series of assemblies. These assemblies can be arranged in one or more layers, if the uniformity is preserved and the resulting fuel satisfies the constraints of deformation and removal of gaseous fission products.

When the stainless ductile casing is a tube, its mechanical deformation after filling is performed either by drawing it through a drawplate at low temperature (less than 100° C.) or even by cold drawing, according to the thickness of the tube. However, the preferred shaping is performed by roller burnishing, with several passes, resulting in fuel rods with a cruciform cross-section. This shaping is described in greater detail in the discussion of the embodiments of the invention.

When the stainless ductile casing has a flattened shape, it can be mechanically deformed by pressing or rolling. Thus, a plate-type fuel can be produced.

The steps of cutting and optionally finishing specific to each nuclear plant are known to a person skilled in the art and are not described in detail here.

To conclude, it is worth mentioning the possibilities of optimisation offered by the method for adapting it to the various possible compositions of fissile material and optional elements intended to enhance the heat transfer or the performance under irradiation. The diameters of the elementary wires can be adjusted, there are a number of alternatives to the “weaving”, and there are several methods for compressing the wires, with various percentages of gaps.

### BRIEF DESCRIPTION OF THE DRAWINGS

The invention will be better understood and other advantages and features will appear in the following description, given as a non-limiting example, accompanied by appended drawings in which:

FIG. 1 shows a side view of a braid according to the invention mounted in a sheath,

FIG. 2 is a cross-section along axis XX of FIG. 1;

FIG. 3 shows a cross-section view along axis XX of the braid and sheath assembly as it is passed over a roller train,

FIG. 4 shows a cross-section view along axis XX of the braid and sheath assembly after it has been shaped by roller burnishing.

### DETAILED DESCRIPTION OF SPECIFIC EMBODIMENTS

UMo wires can be produced and braided together. The UMo wires can also be combined with other wires. For example, to improve the conductivity of the material, UMo wires can be combined with copper wires. Similarly, to dilute the uranium content of the fuel, the UMo wires can be braided with carbon and/or zirconium wires.

As an example, a fuel braid will be produced with a highly uniform uraniferous UMo wire and decreasing proportions of copper wires, then exclusively with UMo wires.

In consideration of the allowable constraints associated with the use of UMo, the first trials were performed using steel 304, of which the metallurgical characteristics are recognised as being equivalent. Production with UMo, which is currently in progress, confirms this equivalence. For the sake of conciseness, only UMo will be discussed.

First, a UMo wire is created with a diameter between 10 μm and 100 μm. UMo wires can be obtained by means of the rotating plate method (see document [3]) optimised for the physical characteristics specific to this alloy. This method is based on the projection, on a rotating disk, of a molten alloy stream. With this method, the wires have a diameter and a controlled chemical composition.

To prepare the wire made of a UMo alloy, for example, a uranium alloy with 8% by weight of molybdenum, the uranium and the alloy element are weighed and placed in a crucible heated by a high-frequency generator. When the temperature is high enough, the fluid mass of the UMo alloy in the form of a stream is fused and said stream is placed in contact with a quenching fluid agitated by a centrifugal rotation movement. The fusion is performed in an inert gas atmosphere and the metal or alloy stream being fused is surrounded by an inert gas envelope. The inert gas can be selected from argon, nitrogen, helium and will have a pressure of between 1 and 15 bars. The metal or alloy stream being fused, which is enveloped by this gas, passes through the opening of the envelope surrounding the crucible, and the metal or alloy stream being fused, still enveloped by an inert gas, follows its generally straight path until it collides with the quenching fluid curtain, for example water moving in a rapid centrifugal movement. The linear speed of the quenching fluid (in this case water) at the point of contact can be between 10 and 60 m/sec. In this example, it is 40 m/sec. At the point of contact, the inert gas envelope surrounding the stream of metal or alloy being fused penetrates the water mass and is rapidly atomised and quenched, preferably at the speed already indicated above.

In the same way, 200 to 400 wires are created with a diameter of 0.15 mm, then assembled into a single compound strand. For example, this assembly has 216 elementary wires stranded into 9 single strands (or spindles), which are again stranded together without a central strand. Experiments have been conducted in particular with decreasing percentages of copper wires, then with all elementary wires made of UMo.

When copper wires are added, the components are mixed. To do this, a braid is mechanically produced using uraniferous wire and other additional wires: a mixed braid is obtained: UX+Y with X=Mo and Y=Cu.

To produce the braid, the conventional method consisting of winding and weaving the wires using several reels depending on the desired shape of the braid can be used. All wires can also, for example, be twisted together in the same direction. The braid obtained has a diameter between 2 mm and 10 mm in order to be inserted into a tube with an external diameter of 5 mm and a thickness of 0.15 mm. Its density is around 50%, that is, in the cross-section of this braid, 50% of the surface of this cross-section would consist of wires, and the remainder would be gaps, enabling it to be easily inserted into a tube with a smaller diameter.

In addition, a stainless ductile tube with a circular cross-section, which will contain the braid, is produced: the tube will act as a sheath. It will preferably be made of stainless steel 316 L or 316 LN.

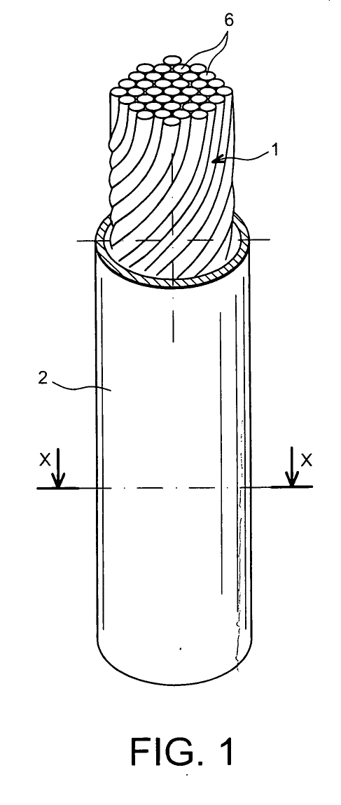

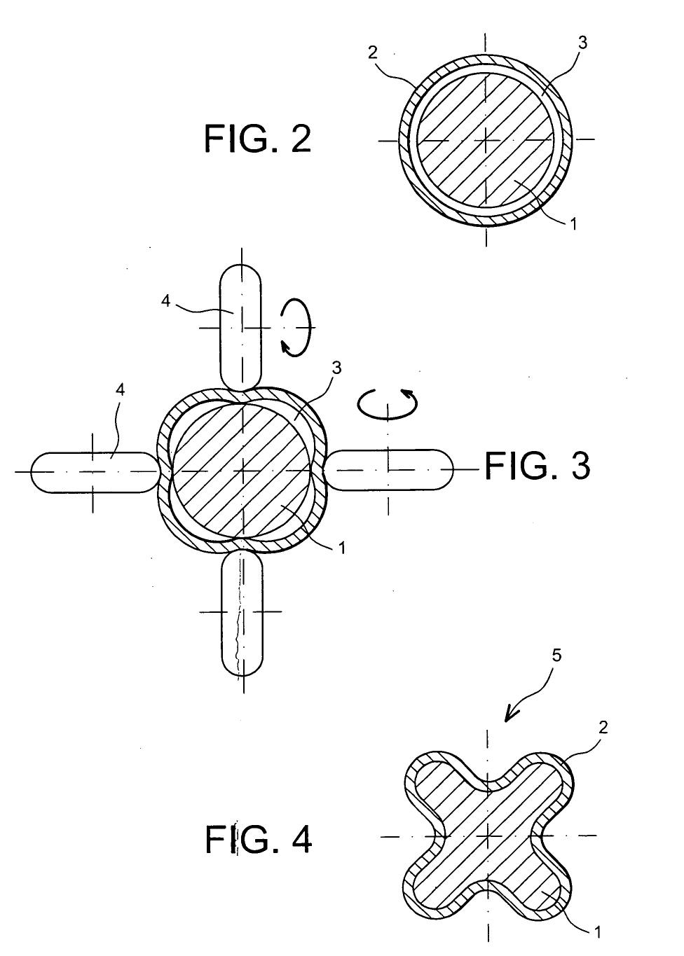

Then, the braid 1 is mounted in its sheath 2 (see FIG. 1) by drawing. FIG. 2 shows that between the braid 1 and the sheath 2, there is a clearance 3 necessary for the braid to be able to be inserted into the sheath. In practice, the diameter of the wire is greater than that of the tube, but this wire, which is not very dense (50% wires, 50% gaps), can be easily compressed: the clearance 3 shows this compressibility.

Finally, the mechanical deformation is carried out, at low temperature (less than 100° C.) or by cold deformation. If a cruciform fuel is desired, this deformation can be created by means of a series of passages over a roller train 4 of which the profile is designed to produce the desired cross shape (see FIG. 3). This is called roller burnishing or co-burnishing. A fuel “rod” element 5 is thus obtained with a cruciform cross-section (see FIG. 4).

The clearance 3 located between the braid and the sheath is a function of the deformation imposed on the sheath. To perform the shaping, a series of passages of the fuel rod over a roller train at a moderate temperature is performed. Once the deformation is completed, said clearance is zero and the braid has a theoretical density between 80% and 90%, in consideration of the 10% of the surface of a cross-section occupied by gaps, the theoretical density of 90% corresponds to the case in which all of the elementary wires are made of UMo.

It should be noted that the intensity of the compression of the fuel rod as it is shaped is carefully measured so that small gaps are left between the various wires of the braid so that the gaseous fission by-products can be removed. With this aim, it is possible, for example, to deform the wires, which initially have a cylindrical cross-section, by compression and to ensure that the surfaces of two adjacent wires in contact with one another fit together. This deformation is preferably continued until an almost polygonal cross-section is obtained for most of the wires, while the portions not in contact with another wire will obviously not acquire this polygonal surface. The wires are crushed slightly, giving then a slightly polygonal cross-section, which significantly enhances the heat transfer. More specifically, “slightly polygonal” means that two convex surfaces pressed against one another have local deformations tending to flatten them and fit them together specifically.

The fuel rod can also be shaped by drawing the “fuel rod” assembly through a drawplate with a suitable shape. The principle lies in the hypothesis that the materials (sheath+braid) pass through the drawplate without sliding with respect to one another. Thus, according to the invention, it is possible to produce cruciform nuclear fuels intended to obtain fuels with a high uranium density (density greater than 2 gU/cm³). In this case, the conventional shaping method of rolling is preferably used. It is also possible to produce cylindrical fuels intended to obtain fuels with a uranium density greater than 10 gU/cm³. In this case, the shaping method used is preferably drawing, but rolling with an appropriate form may also be suitable.

### BIBLIOGRAPHY

[1] “Design of high density gamma-phase uranium, alloys for leu dispersion fuel applications”, G. L. HOFMAN, M. K. MEYER, A. E. RAY, (1998).
[2] “Boron poisoning experiments at the PIK mock-up”, booklet published by the Russian Academy of Science, St Petersburg Nuclear Physics Institute, preprint 2426, 2001.
[3] “Procédé de préparation de particules de métal ou d'alliage de métal nucléaire”, patent application FR-A-2 814 097 of Sep. 21, 2000.

1-19. (canceled)

20: High-density fissile material nuclear fuel, in a form of an assembly of elementary wires, most of which are constituted by fissile material, wherein said elementary wires are assembled by stranding, braiding, or weaving and said assembly is contained in a stainless ductile casing, which elementary wires are compressed by deformation of said casing, and the elementary wires made of fissile material are fine enough to allow for size accommodation of the fuel under effects of irradiation during burnup and for gaseous fission products to be removed.

21: Nuclear fuel according to claim 20, wherein the casing is deformed until gaps between the elementary wires occupy only 3 to 15% of the internal cross-section of the casing after deformation.

22: Nuclear fuel according to claim 20, wherein the casing is deformed so that the cross-section of the elementary wires is deformed, and the cross-sections of two adjacent of the elementary wires fit together.

23: Nuclear fuel according to claim 20, wherein the fissile material is selected from the group including uranium, plutonium, americium, their alloys or a combination of several of these elements.

24: Nuclear fuel according to claim 23, wherein said alloys are selected from the group including UMo and UAl.

25: Nuclear fuel according to claim 24, wherein the fissile material is a UMo alloy comprising around 8% by mass of molybdenum.

26: Nuclear fuel according to claim 20, wherein the elementary wires have a diameter between 10 μm and 100 μm.

27: Nuclear fuel according to claim 20, wherein the assembly of elementary wires includes only elementary wires having the same composition.

28: Nuclear fuel according to claim 20, wherein the assembly of elementary wires includes elementary wires having different compositions.

29: Nuclear fuel according to claim 20, wherein the elementary wires have identical diameters.

30: Nuclear fuel according to claim 20, wherein the elementary wires have different diameters.

31: Nuclear fuel according to claim 20, wherein the assembly of elementary wires has a braid form.

32: Nuclear fuel according to claim 20, wherein the assembly of elementary wires has a strand form.

33: Nuclear fuel according to claim 32, wherein the strand form is a compound strand free of a central strand.

34: Nuclear fuel according to claim 20, wherein the assembly of elementary wires is woven.

35: Method for producing a nuclear fuel according to claim 20, comprising:
producing elementary wires having a predetermined composition, most of which are wires of fissile material;
producing at least one assembly using said elementary wires;
placing the assembly in a stainless ductile casing; and
shaping the filled casing.

36: Method for producing a nuclear fuel according to claim 35, wherein the casing is a tube, there is only one assembly, and it is shaped by drawing through a drawplate or by rolling.

37: Method for producing a nuclear fuel according to claim 35, wherein the casing is a tube, there is only one assembly, and it is shaped by roller burnishing.

38: Method according to claim 35, wherein the casing is flattened and contains plural assemblies placed parallel with respect to one another in a uniform manner, and the shaping of the casing thus filled is performed by pressing or rolling.
